(19) United States
(12) Patent Application Publication
(10) Pub. No.: US 2006/0190542 A1
(43) Pub. Date: Aug. 24, 2006

(54) Simplified email system

(76) Inventor: Michael T. Rhoades, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 11/064,609

(22) Filed: Feb. 24, 2005

(51) Int. Cl. G06F 15/16

(52) U.S. Cl. 709/206

(57) ABSTRACT

Email communication between an elderly individual and registered friends and family is facilitated by displaying photographs received by email from registrants on a monitor display screen, displaying visual indicators on said screen in association with photographs of registrants from whom emails have been received, and providing a selection means for selecting a photograph having an associated visual indicator. Upon selection, text emails received from registrants are converted to an audio format and the emails are played. The individual can also send recorded emails to a registrant whose photograph is selected. When an individual initially registers with the system, an email is sent to the user's primary account manager, e.g., a relative, who sends a photograph to the user and invites the user's friends to register and send a photograph to the user's email address.

### BACKGROUND OF THE INVENTION

(1) Field of the Invention

The present invention relates to a simplified email system enabling elderly individuals and others unable to use conventional keyboard based systems to send and receive emails, and in particular to an email system limiting communications to a controlled group of individuals.

(2) Description of the Prior Art

Electronic mail or email has become an essential part of many peoples' lives, greatly facilitating communication between individuals throughout the world. However, the exchange of emails requires the use of a computer with a keyboard and mouse, an Internet connection, and an email client. While the transmission and receipt of emails is a routine matter to most adults and children, the technology and particularly use of a mouse and keyboard can be intimidating to many elderly persons. Therefore, numerous elderly persons who could greatly benefit from email correspondence with friends and relatives are deprived of the opportunity.

Elderly users may also be confused by an email system designed to permit sending of emails to an unlimited number of recipients, with the perceived complexity in selecting the desired recipient. Moreover, the individuals addressed by the present invention seldom desire to communicate with other than a limited number of friends and relatives, and may be confused by spam and other unsolicited messages received when using a conventional email system.

A simplified email system and method that would enable elderly persons and others finding conventional email communications beyond their capabilities would be of considerable utility. In particular, an email system that limited communications to a limited number of selected individuals and simplified selection of the desired individual would find great acceptance by elderly individuals.

### SUMMARY OF THE INVENTION

The present invention relates to a system and method that greatly simplifies the transmission and receipt of emails, enabling use of the system by elderly individuals and others having impaired capabilities that render the use of conventional email systems difficult or impossible. One aspect of the invention is to limit individuals that are able to send emails to, and receive emails from, the user to invited, registered individuals.

Generally, the objectives of the invention are achieved by the use of a conventional computer and monitor, but with a specialized control means to replace the conventional keyboard and mouse, and specialized software that enables the user to select and listen to received emails, and prepare and send audio responses.

Email messages can only be received from, and sent to, invited individuals who have registered with the system and provided a photograph. Instead of email headers and an address book to identify senders and recipients of emails as in a conventional email system, the present invention displays registrants' photographs on the monitor screen, with associated visual indicators being included to show when emails are received. Communications are only with registered individuals whose photographs are displayed, thereby eliminating the need to select recipients in the conventional manner, and the confusion that might result from spam and other email messages from unknown senders.

The present system is comprised of a computer, a monitor with a display screen, a simplified control means for selecting photographs and performing other control functions, and audio output means for playing email messages received from registrants upon selection of a photograph displaying an indicator. An audio input means will usually also be included. The audio input/output means take various forms, such as a speaker and microphone, a headset, or a conventional telephone handset.

The computer and monitor may be supported by a suitable housing, normally in the form of a kiosk-type housing, that enables a user to sit before a desk or writing surface while viewing the monitor screen. The computer is preferably hidden from view for security and to minimize the “technology” image that might be intimidating to some users.

The simplified control means is preferably in the form of two large buttons, e.g., two round buttons having a diameter of from about 2 to 4 inches, that can be easily pressed by the user. Pressing one or the other of these buttons results in various actions, depending on the status of the program. For example, one of the buttons can be used to scroll through the photographs, while the second button can be used to select a given photograph. The buttons can also be used to activate a recorder and send recorded email messages.

The computer has several executable software programs installed, including a client program for transmitting and receiving emails, software for displaying photographs of registrants on the display screen associated with their email addresses, and software for displaying visual indicators associated with the photographs to indicate when an email is received from one or more of the registrants.

The user initiates an email session by logging on to the system, preferably using a biometric device, such as a handprint, fingerprint or iris scanner, or other simplified identifier means. If the user is not registered with the system, the monitor will display a signup screen requesting certain information, including the user's name and the email address of the user's primary account manager, normally a relative, who is responsible for assisting the user in registration of others. Upon completion of the signup screen, the computer software will create a generic display screen for the user and, with the computer client software, send a message to the primary account manager to advise that the user has registered with the system.

The account manager, following instructions sent with the email, will reply to the user's email address with a photograph to identify the account manager. The account manager can also send emails to other persons, referred to herein as friends, who might want to exchange emails with the user, inviting the friends to send a photograph to the user at the user's email address. The account manager and friends who have sent a photograph, collectively referred to herein as registrants, may also send text or voice messages with their emails.

The photographs of the registrants will be displayed on the screen when the user next signs on to the system. If emails have been received from one or more of the registrants, visual indicators associated with the photographs of the registrants who have sent emails will also be displayed. For example, a colored border or frame may be positioned around a photograph to indicate that an email has been received from that registrant.

The user can then scroll through the photographs, e.g., by pressing one of the buttons described above, to move to a photograph with a visual indicator. The desired photograph is then selected, e.g., by pressing the other button. Upon selection, software in the system plays email messages from the user, converting any text email messages into an audio format. The text of text messages, a web screen, photographs or other visual form of communication can also be displayed, if desired.

At the end of each message, the user can press one or the other of the buttons to save or delete the message. If the user wishes to respond, the user can activate a recording session by pressing one of the buttons. After recording the message using the audio input means, the user can press one of the buttons to listen to the message, or the other button to transmit the message. Similarly, the user can initiate an email transmission to a registrant who has not sent an email by selecting the registrant's photograph.

The user may dictate the message before or after the photograph has been selected. If desired, the user's photograph or a video clip of the user can also be transmitted with the email message. The photograph or video clip can be taken with a still camera or web camera mounted, e.g., above the monitor. The camera can be triggered by the user, or automatically when the email is recorded or transmitted.

Thus, the present system and method provides a highly simplified and effective method of email communication that is well within the capabilities of many elderly individuals that are now unable to utilize email as a means of communicating with relatives and friends. Furthermore, the present system and method, by limiting the individuals with whom the user can communicate to invited registrants avoids confusion resulting from the choices afforded by conventional email systems and the receipt of unsolicited emails.

It will also be apparent after reading this specification that other useful features can be added to the system. Representative optional features include the following:
1. A wireless link to a Personal Emergency Response System (PERS) which can include a panic button, a heartbeat monitor, a wander sensor (alerts when the signal disappears), and a motion sensor (which can be activated, for example, during a fall).
2. Software to send messages, updates, and alerts to a designated person via a variety of outputs such as text messaging, auditory cell phone calls, emails, pagers, etc.
3. Limited and secure web access for physicians, nutritionists, and pharmacists who would like to update pill minders, suggest meal ideas, monitor vitals, etc.
4. Simplified links to products, grocery shopping, Meals on Wheels, etc., allowing home delivery of necessities.
5. Calendars, contact information, appointment reminders, etc.
6. Telephone connections allowing the user to select a photograph of a family member for automated dialing.
7. Entertainment in the form of memory enhancing games, news articles, television streams, and archived video content.
8. Voice command and voice response operations.
9. Photo albums organized by dates with a voice summary.
10. Direct or wireless portals for home health caregivers who need to update medical records and/or request information.
11. Secure terminals for continuing education of facility staff.

The system and method of the present invention can be in the form of a free-standing kiosk in the user's home or other location such as an assisted living facility. Alternatively, the system can comprise a computer and monitor used for other purposes with the additional hardware and software being installed, permitting use by the elderly person of a computer that is also available to other family members.

The system and method as described herein are primarily with reference to a system using a client software program that is adapted to operate on a home computer. In such systems, the client program installed on the user's computer sends email messages via an SMTP protocol to a remote email server, usually operated by an Internet Service Provider. The server determines, via a domain server, the DNS address corresponding to the email address and forwards the email to another server that stores messages addressed to the recipient. Stored messages are then downloaded to the recipient when the recipient logs on to receive email messages, normally using a POP protocol.

It will be understood, however, that the present invention also contemplates operation of the claimed system and method via a web server. In this alternative, certain of the method steps will be performed on a remote server instead of on the user's computer. However, the components of the system and the steps of the method remain the same. It will also be appreciated that the term “email” as used herein is intended in its broadest sense to include all forms of electronic mail, and not merely text transmissions and video files. For example, the information may be transmitted in the form of web screens or streaming audio.

### BRIEF DESCRIPTION OF THE DRAWINGS

FIG. 1 is a perspective view of the hardware components of the system.

FIG. 2 is a perspective view of a simplified access device that can be attached to the computer USB port for use instead of a conventional keyboard.

FIG. 3 is a flow diagram of one embodiment of the method of the invention.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

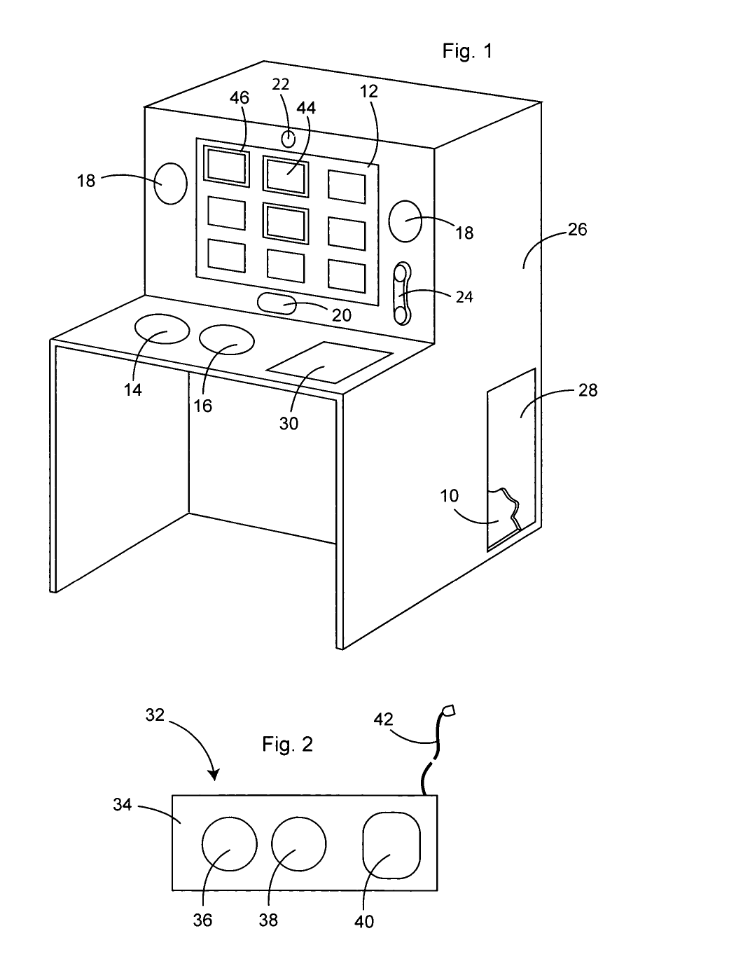

As best shown in FIG. 1, a preferred embodiment of the system of the present invention is comprised of a computer or CPU 10, a monitor with a display screen 12, a simplified control means in the form of buttons 14 and 16, audio output means, e.g., speakers 18, and audio input means, e.g., a microphone 20. A still or web camera 22 can also be included. The system may also include a convention telephone-type handset 24 as a supplement to, or instead of, speakers 18 and microphone 20.

When the system is constructed as a free-standing unit, these components may be mounted within a kiosk-type housing 26 that enables a user to sit before a desk or writing surface while viewing monitor 12. Computer 10 is hidden from view behind a door 28 in housing 26. A biometric security control, shown as hand pad 30, can also be included to provide a simplified way for elderly persons to “sign-on” to a session and download email messages.

Computer 10 includes several executable software programs including a client program for transmitting and receiving emails, software for displaying photographs of registrants on the display screen, and software for displaying visual indicator means associated with the photographs for indicating when emails are received from one or more of the registrants.

While the preferred embodiment is described in terms of a free-standing unit, it will be understood that the system can also be constructed by adaptation of an existing desktop computer. For example, a simplified controller 32, as illustrated in FIG. 2, with a base 34 supporting buttons 36 and 38, and hand pad 40 can be attached to a computer USB port with cable 42, and the required software can be installed in the computer. The remaining components of the system, i.e., the monitor, speakers and microphone, will usually be part of the existing computer.

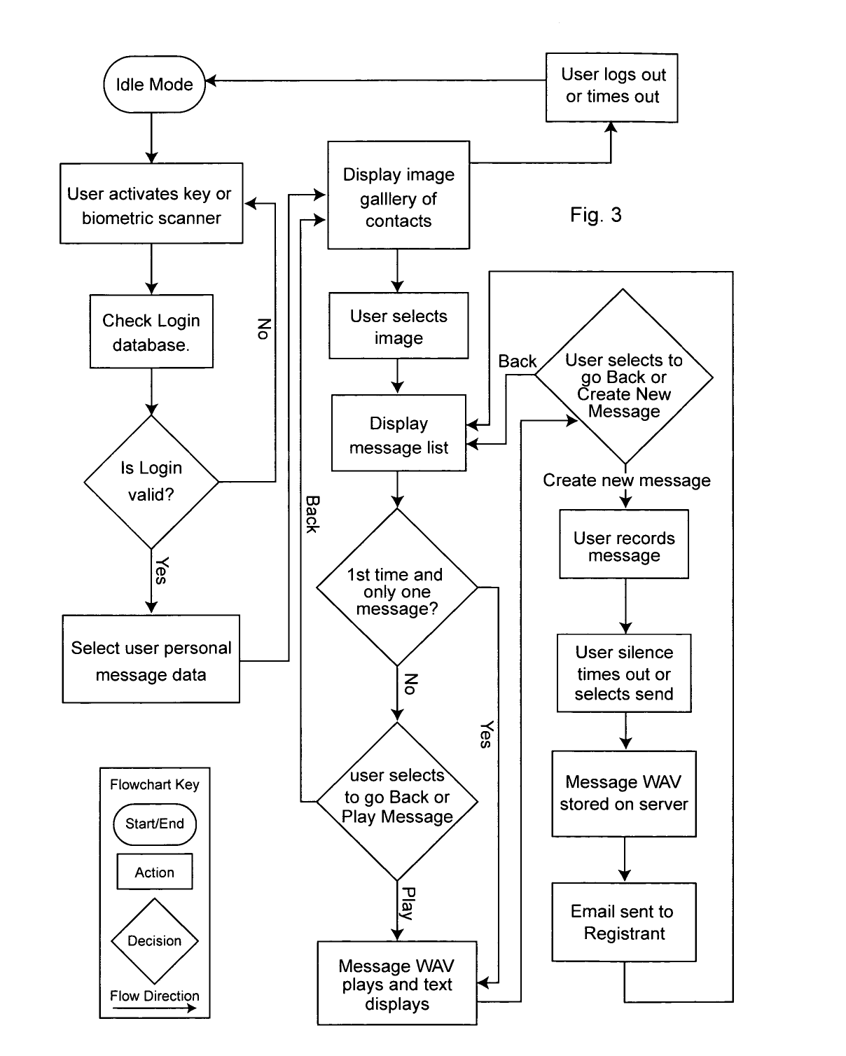

One embodiment of the method of the invention is outlined in FIG. 3. It will be understood, however, that the essential steps of the method as herein described are adaptable to numerous embodiments. When practicing the method of the invention, a user logs on to the system by placing his or her hand on pad 30. If the user is logging on to the system for the first time, monitor 12 displays a signup screen requesting certain information, including the user's name and the email address of the user's primary account manager. Upon completion of the signup screen, the computer software will create a generic display screen for the user and send a message to the primary account manager to advise that the user has registered with the system.

When the user next signs on to the system, the computer software will access the remote server to download any email and photographs of the primary account manager and others registering to communicate with the user, collectively registrants. The software then displays photographs 44 of the registrants on the screen, and also displays visual indicators 46, e.g., colored frames, in association with any photographs of registrants who have sent emails to the user.

The user can then scroll through the photographs 44, e.g., by pressing one of the buttons 14 and 16, which will preferably be of different colors, e.g., green and red, to move to a photograph with a visual indicator 46. The desired photograph is then selected, e.g., by pressing one of buttons 14 and 16. Upon selection, software in the system plays any email messages from the displayed registrant, converting any text email messages into an audio format. At the end of each message, the user can press one or the other of the buttons to save or delete the message.

In order to send an email, either in response to a received email or as an initial email, the user selects the photograph of the desired recipient and activates a recording session by pressing one of buttons 14 and 16. After recording the message using microphone 20, the user presses one of buttons 14 and 16 to listen to the message, or the other of buttons 14 and 16 to transmit the message. The client software then sends the message to the email address associated with the selected photograph.

Thus, the elderly user can start an email session by simply placing his or her hand on hand pad 30. Upon initiation of the session, photographs of all registrants with whom the user communicates will be displayed on the monitor screen. The user can then determine who has sent emails by looking at monitor 12 to see which photographs include a visual indicator denoting that an email has been received. The user can then listen to the email, whether the email was initially in text or audio format, by using the two buttons to select the photograph.

Sending of emails is equally simple. The elderly user selects the photograph of the desired recipient, records a message by speaking into microphone 20, and uses one of buttons 14 and 16 to send the email message to the selected registrant. It will be apparent that the photograph can be selected before or after dictation of the message, depending on the software design.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A system for electronic mail communication between an elderly user and registrants comprising:
a) a computer;
b) a monitor with a display screen;
c) client software executable on said computer for sending and receiving emails between the user and a plurality of registrants;
d) software executable on said computer for displaying registrant photographs on the display screen and associating the photographs with registrant email addresses;
e) software executable on said computer for displaying visual indicators associated with the photographs to indicate when an email is received from one or more registrants;
f) selection means for selecting photographs with a displayed visual indicator; and
g) audio output means for playing email messages received from registrants upon selection of photographs displaying visual indicators.

2. The system of claim 1, further including audio input means for recording and transmitting messages from the user.

3. The system of claim 1, further including biometric identification means.

4. The system of claim 1, further including software executable on said computer to display a registration setup screen requesting information including the email address of a primary account manager.

5. The system of claim 1, wherein the selection means is comprised of two buttons that can be selectively pressed by the user.

6. The system of claim 1, wherein said visual indicators are lighted frames around said photographs.

7. The system of claim 1, further including a housing with an enclosure for said computer and a desktop surface.

8. A system for electronic mail communication between an elderly user and registrants comprising:
a) a computer;
b) a monitor with a display screen;
c) audio output means;
d) client software executable on said computer for sending and receiving emails between the user and a plurality of registrants;
e) software executable on said computer for displaying registrant photographs on the display screen and associating the photographs with registrant email addresses;
f) software executable on said computer for displaying visual indicator means associated with the photographs to indicate when an email is received from one or more registrants;
g) software executable on said computer for recording messages; and
h) selection means for selecting photographs with a displayed visual indicator.

9. The system of claim 8, further including biometric identification means.

10. The system of claim 8, further including software executable on said computer to display a registration setup screen requesting information including the email address of a primary account manager.

11. The system of claim 8, wherein the selection means is comprised of two buttons that can be selectively pressed by the user.

12. The system of claim 11, wherein said buttons are connected to the USB port of the computer.

13. The system of claim 8, wherein said visual indicators are lighted frames around said photographs.

14. The system of claim 8, further including a housing with an enclosure for said computer and a desktop surface.

15. A method for facilitating email communication between an individual and registrants using a computer having a display screen comprising:
a) displaying photographs received by email from registrants on a monitor display screen;
b) displaying visual indicators on said screen in association with photographs of registrants from whom emails have been received;
c) providing a selection means for selecting a photograph having an associated visual indicator; and
d) playing emails received from the registrants when photographs are selected.

16. The method of claim 15, further including providing means for recording an email message to a registrant and transmitting a recorded email message to a registrant whose photograph is selected.

17. The method of claim 15, wherein said visual indicators are colored frames around said photographs.

18. The method of claim 15, wherein said selection means includes first and second buttons that can be activated by said user.

19. The method of claim 15, further including initially registering said user and sending an email to the email address of an account manager.

20. The method of claim 15, further including the step of logging on with a biometric identifier.
